(19) United States
(12) Patent Application Publication
(10) Pub. No.: US 2023/0322386 A1
(43) Pub. Date: Oct. 12, 2023

(54) MULTI-RECEPTACLE PAYLOAD ASSEMBLY FOR AIRCRAFT

(71) Applicant: Georgian Aerospace, LLC, Chesterfield, MO (US)

(72) Inventors: Michael J. Scimone, Ballwin, MO (US); Justin R. Foster, Troy, MO (US)

(21) Appl. No.: 18/188,222

(22) Filed: Mar. 22, 2023

Related U.S. Application Data
(60) Provisional application No. 63/362,350, filed on Apr. 1, 2022.

(51) Int. Cl. B64D 9/00; B64F 5/10; B64C 1/14

(52) U.S. Cl. CPC B64D 9/00; B64C 1/1407; B64C 1/1484; B64F 5/10

(57) ABSTRACT

An aircraft including a support structure, an outer skin connected to the support structure, a first port extending through the outer skin and defining a first break in the support structure. The aircraft also includes a first receptacle attached to the support structure proximate the first port and defining a first opening, a ball-mounted sensor assembly received in the first receptacle and extending downward from the outer skin, a second port extending through the outer skin and defining a second break in the support structure, a second receptacle attached to the support structure proximate the second port and defining a second opening. A method of retrofitting an aircraft to accommodate a ball-mounted sensor assembly and a payload is also disclosed.

### CROSS-REFERENCE TO RELATED APPLICATIONS

This application claims the benefit of U.S. Provisional Patent Application Serial No. 63/362,350, filed on Apr. 1, 2022, the disclosure of which is hereby incorporated by reference in its entirety.

### FIELD

The field of the disclosure relates generally to aircraft, and more particularly to aircraft carrying sensors or payloads.

### BACKGROUND

Some aircraft may include payloads or other components positioned to be at least partially exposed to an external environment while the aircraft is in flight. For example, the payload may include a camera or other optical imaging device, an atmospheric monitor, a sonobuoy, or any other suitable sensor, antenna, ordnance, countermeasure, or collection/dispersion device. Some such payloads may be installed adjacent a port defined in the aircraft outer skin that provides at least partial access to the external environment. An aircraft may be retrofitted to add a port capable of accommodating such a payload. However, to accommodate a sufficiently large port, it may be necessary to remove a portion of the load-bearing structural frame of the aircraft, which may reduce the performance capabilities of the aircraft. Additionally, payloads may need to be removed for repair, replacement, substitution with a different payload, or operation with no payload for particular flight operations. However, payload removal and reinstallation may require additional modifications to the aircraft port and/or other time- and labor-intensive operations, during which time the aircraft must be removed from service. Improved payload mounting, removal and reinstallation systems are needed.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

In one aspect, an aircraft includes a support structure, an outer skin connected to the support structure, a first port extending through the outer skin and defining a first break in the support structure, a first receptacle attached to the support structure proximate the first port and defining a first opening, a ball-mounted sensor assembly received in the first receptacle and extending downward from the outer skin, a second port extending through the outer skin and defining a second break in the support structure, a second receptacle attached to the support structure proximate the second port and defining a second opening, a payload mounted in the second receptacle, and a door selectively positionable over the second port and movable between an open position and a closed position.

In another aspect, a method of retrofitting an aircraft to accommodate a ball-mounted sensor assembly and a payload is provided. The aircraft includes a support structure and an outer skin. The method includes removing a first portion of the support structure to define a first break, placing a first port in the first break such that the first port extends through the outer skin, connecting a first receptacle defining a first opening to the support structure proximate the first port, placing the ball-mounted sensor assembly within the first opening of the first receptacle such that the ball-mounted sensor assembly extends downward from the outer skin, removing a second portion of the support structure to define a second break, placing a second port in the second break such that the second port extends through the outer skin, connecting a second receptacle defining a second opening to the support structure proximate the second port, and placing the payload within the second opening of the second receptacle.

Various refinements exist of the features noted in relation to the above-mentioned aspects of the present disclosure. Additional features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective view of a first embodiment of an aircraft including a multi-receptacle payload assembly.

FIG. 2 is a perspective view of the first embodiment of an aircraft shown in FIG. 1 including an embodiment of a support structure.

FIG. 3 is another perspective view of the first embodiment of an aircraft shown in FIG. 1 having a portion of the support structure removed adjacent an embodiment of a port.

FIG. 4 is another perspective view of the first embodiment of an aircraft shown in FIG. 1 having an embodiment of a receptacle installed in the port.

FIG. 5 is a perspective view of a first receptacle for receiving a ball-mounted sensor assembly mounted therein.

FIG. 6 is an interior perspective view of the multi-receptacle payload assembly shown in FIG. 1.

FIG. 7 is an exterior perspective view of the multi-receptacle payload assembly shown in FIG. 1.

FIG. 8 is a perspective view of a second or third receptacle of the multi-receptacle payload assembly shown in FIG. 1.

FIG. 9 is a side view of the multi-receptacle payload assembly shown in FIG. 1.

FIG. 10 is a side view of a second embodiment of an aircraft including the multi-receptacle payload assembly shown in FIGS. 7 and 9.

FIG. 11 is an exterior perspective view of the second embodiment of an aircraft shown in FIG. 10.

Corresponding reference characters indicate corresponding parts throughout the drawings.

### DETAILED DESCRIPTION

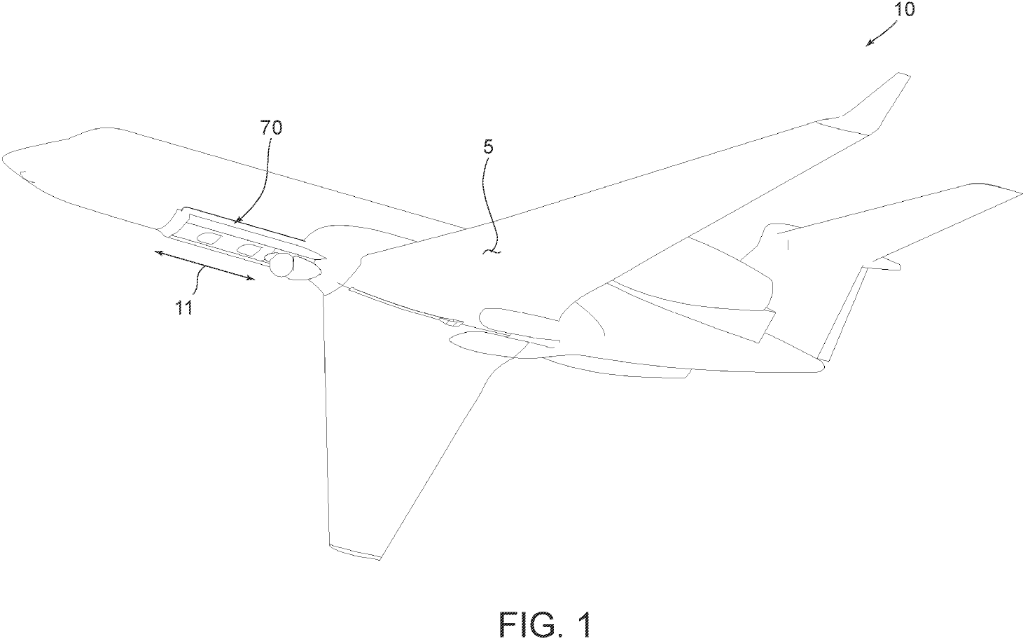

FIG. 1 is a perspective view of an aircraft 10. The aircraft 10 of the illustrated embodiment is a fixed wing aircraft, e.g., a small jet aircraft such as a business jet. The aircraft 10 may alternatively be a propeller-driven aircraft, or any other suitable type of aircraft, for example and without limitation, a rotorcraft, a lighter-than-air aircraft including a dirigible, or any type of remotely piloted or “drone” aircraft. The aircraft 10 of the illustrated embodiment includes a wing 5 and a multi-receptacle payload assembly 70 located forward of the wing 5 relative to a longitudinal axis 11.

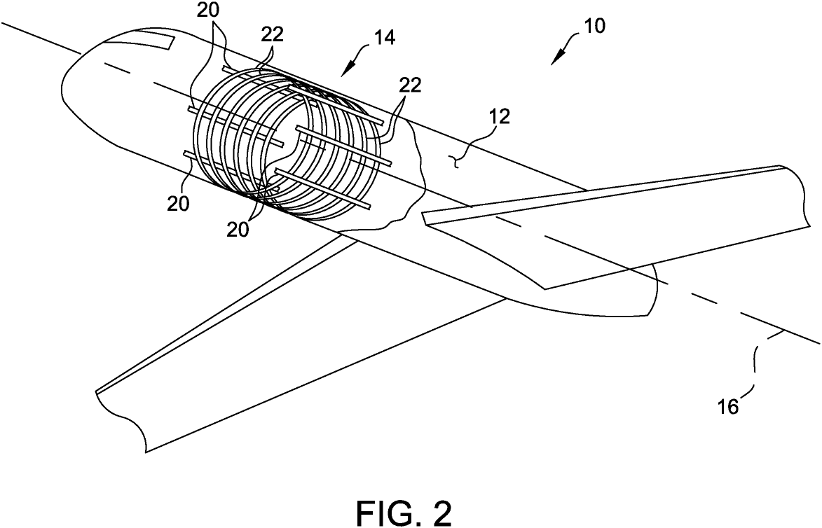

With reference to FIG. 2, a support structure 14 is configured to provide internal structural support and stability to the aircraft 10 throughout a range of flight and ground operations of the aircraft 10. An outer skin 12 of the aircraft 10 is connected to the support structure 14. In some embodiments, at least a portion of an interior of the aircraft 10 is pressurized, and the outer skin 12 defines at least a portion of the pressure boundary between the interior of the aircraft 10 and an external environment.

For example, in the illustrated embodiment, the support structure 14 includes a plurality of longitudinally extending stringers 20 aligned generally parallel to a longitudinal axis 16 of the aircraft 10. The term “stringers” as used in this disclosure includes stringers, longerons, and any other similar type of longitudinally extending structural support member. The support structure 14 also includes a plurality of ribs 22 coupled to the stringers 20. Each rib 22 extends circumferentially in a plane generally perpendicular to the longitudinal axis 16. Although ribs 22 are illustrated as extending in a closed loop about an entire circumference of the aircraft 10, at least one rib 22 may alternatively extend over only a portion of the circumference of the aircraft 10. The term “ribs” as used in this disclosure includes ribs, frames, formers, and any other similar type of circumferentially extending structural support member. In alternative embodiments, the support structure 14 includes any suitable structure that enables the support structure 14 to function as described herein.

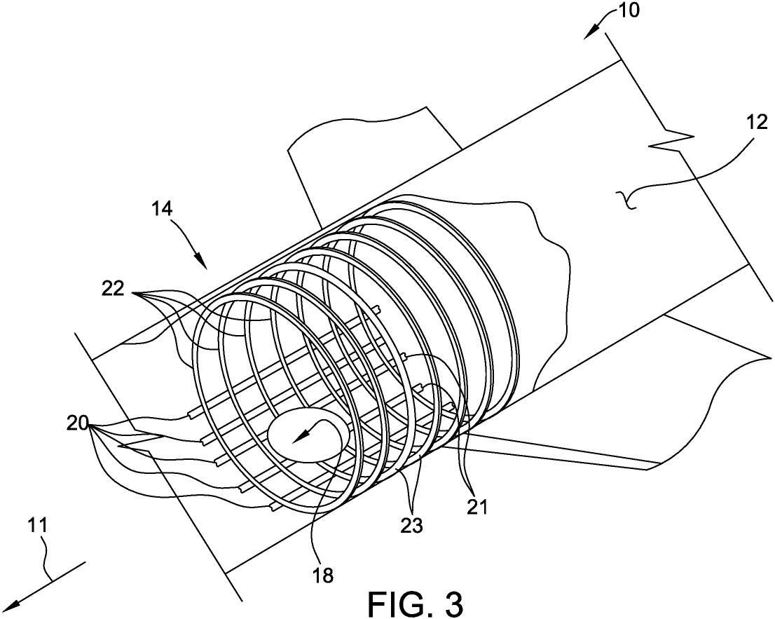

FIG. 3 is another perspective view of the aircraft 10 with a portion of the support structure 14 removed adjacent a port 18. The port 18 is defined in, and extends through, the aircraft outer skin 12. For example, the port 18 may be formed in the outer skin 12 in a retrofitting process, or, alternatively, the outer skin 12 may be initially formed with the port 18 defined therein. The port 18 also defines a break in the adjacent support structure 14 as shown. For example, in order to accommodate a payload adjacent the port 18, a portion of the support structure 14 overlying the port 18 is removed in a retrofitting process, or, alternatively, the support structure 14 is initially formed without the overlying portion. In alternative embodiments, the port 18 does not define a break in the support structure 14.

For example, the port 18 suitably defines a break in at least one stringer 20. More specifically, a portion of the at least one stringer 20 overlying the first port 18 is removed in a retrofitting process, or, alternatively, the at least one stringer 20 is initially formed without the overlying portion. Each such at least one stringer 20, designated as a discontinuous stringer 21, includes an aft portion that extends in a longitudinally forward direction 11 to proximate an aft edge of the port 18, and a forward portion that resumes from a forward edge of the port 18 and extends in the forward direction 11, such that the discontinuous stringer 21 does not extend over the port 18. For example, in the illustrated embodiment, the plurality of stringers 20 includes two discontinuous stringers 21. In alternative embodiments, the plurality of stringers 20 includes any suitable number of discontinuous stringers 21, including zero, that enables the port 18 to function as described herein.

Similarly, the port 18 of this example defines a break in at least one rib 22. More specifically, a portion of the at least one rib 22 overlying the first port 18 is removed in a retrofitting process, or, alternatively, the at least one rib 22 is initially formed without the overlying portion. Each such at least one rib 22, designated as a discontinuous rib 23, includes a first portion that extends in a first lateral direction from a first lateral edge of the port 18, and a second portion that extends in an opposite lateral direction from an opposite lateral edge of the port 18, such that the discontinuous rib 23 does not extend over the port 18. For example, in the illustrated embodiment, the plurality of ribs 22 includes two discontinuous ribs 23. In alternative embodiments, the plurality of ribs 22 includes any suitable number of discontinuous ribs 23, including zero, that enables the port 18 to function as described herein.

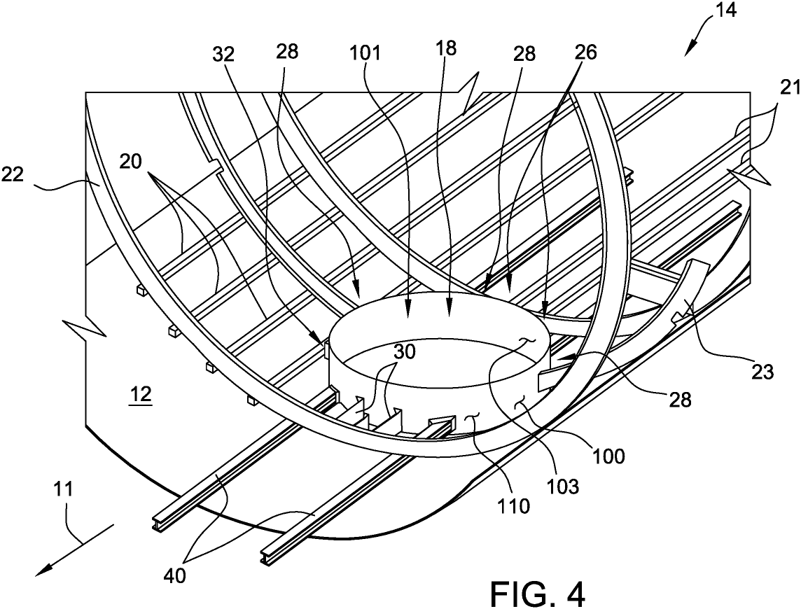

With reference to FIG. 4, a receptacle 100 is attached to the support structure 14 proximate the port 18. The receptacle 100 includes an opening 101 defined therein by an inner surface 103 of the housing 110. As shown, the opening 101 extends completely through the receptacle 100. In alternative embodiments, the opening 101 extends only partially within the receptacle 100. The opening 101 of the receptacle 100 may be coaxial with and largely the same shape and size as the break in the support structure 14. That is, the opening 101 and the break in the support structure may be fully or partially aligned. The receptacle 100 is installed in the port 18 to facilitate installation and/or removal of a ball-mounted sensor assembly or a payload adjacent the port 18. The ball-mounted sensor assembly and the payload will be discussed in greater detail further below. The receptacle 100 includes a housing 110 shaped to be received in the port 18. In the illustrated embodiment, the housing 110 is generally annular in shape.

The receptacle 100 may be load-bearing so as to restore at least a portion of the structural strength lost due to discontinuities in the support structure 14, particularly in embodiments in which the aircraft includes a pressurized cabin proximate the port 18. More specifically, the receptacle 100 is coupled to portions of the support structure 14 proximate the port 18, such that the receptacle 100 routes at least a portion of the load borne by the support structure around the break defined by the port. For example, in certain embodiments, the receptacle 100 is coupled to the discontinuous stringers 21 at the free ends 26 of the discontinuous stringers 21 proximate the first port 18, and/or to the discontinuous ribs 23 at the free ends 28 of the discontinuous ribs 23 proximate the first port 18.

The receptacle 100 is attached to or connected to at least one continuous stringer 20 and/or at least one continuous rib 22 that extends past the port 18. For example, in the illustrated embodiment, the receptacle 100 is coupled to a continuous rib 22 forward of the receptacle 100 via at least one clip 30, and to a continuous stringer 20 lateral of the receptacle 100 via at least one clip 32. In alternative embodiments, the receptacle 100 is coupled to portions of the support structure 14 proximate the port 18 in any suitable fashion that enables the receptacle 100 to function as described herein. For example, in embodiments in which the receptacle is included in an as-built aircraft, the receptacle 100 may be integrally formed with at one stringer 20 and/or rib 22.

The receptacle 100 is connected to at least one additional interior member 40. The additional interior members 40 are attached interiorly to the outer skin 12 and/or the pre-existing support structure 14 of the aircraft 10 in a retrofitting process. Alternatively, the aircraft 10 is initially formed to include the additional interior members 40. In some embodiments, the interior members 40 further enable the receptacle 100 to route the load borne by the support structure around the break defined by the port.

The interior members 40 each extend in the forward direction 11 from the receptacle 100 across at least two ribs 22, and in the opposite, backward direction from the receptacle 100 across at least one rib 22. For example, the interior members 40 span from a continuous rib 22, across the at least one discontinuous rib 23, and to another continuous rib 22. In some embodiments, the span of the interior members 40 across the at least one discontinuous rib 23 at least partially compensates for the load bearing capability that is lost by removing, or by fabricating the support structure 14 without, portions of the at least one discontinuous rib 23. In alternative embodiments, each of the additional interior members 40 extends across any suitable portion of the support structure 14 that enables the additional interior members 40 to function as described herein.

Additionally, the receptacle housing 110 is suitably formed to enhance a load-bearing capacity of the receptacle 100. In the illustrated embodiment, a load-bearing capacity of the receptacle 100 is enhanced by integrally forming the receptacle housing 110, such as from a high-strength alloy. For example, the receptacle housing 110 is formed from a unitary block of material in a single machining. Alternatively, the receptacle housing 110 is cast as a single casting. The initial single casting may be machined thereafter. Alternatively, the receptacle housing 110 may be integrally formed using an additive manufacturing process, in which a computer numerically controlled (CNC) machine deposits successive thin layers of material to form the receptacle housing 110. The initial additively formed housing 110 may be machined thereafter. In some embodiments, the successive layers of material are deposited using at least one of a direct metal laser melting (DMLM) process, a direct metal laser sintering (DMLS) process, and a selective laser sintering (SLS) process, or another suitable additive manufacturing process. In alternative embodiments, the receptacle housing 110 is formed from any suitable material in any suitable number of subparts, using any suitable manufacturing process, that enables receptacle 100 to function as described herein.

A technical effect of coupling the receptacle 100 to the support structure 14, and/or of forming the receptacle housing 110 unitarily, is that a larger portion of the support structure 14 proximate the port 18 may be removed to accommodate a larger payload without reducing the structural integrity of the aircraft 10. In some embodiments, retrofit of the aircraft 10 to add the port and relatively large payload does not limit an operational profile of the aircraft 10.

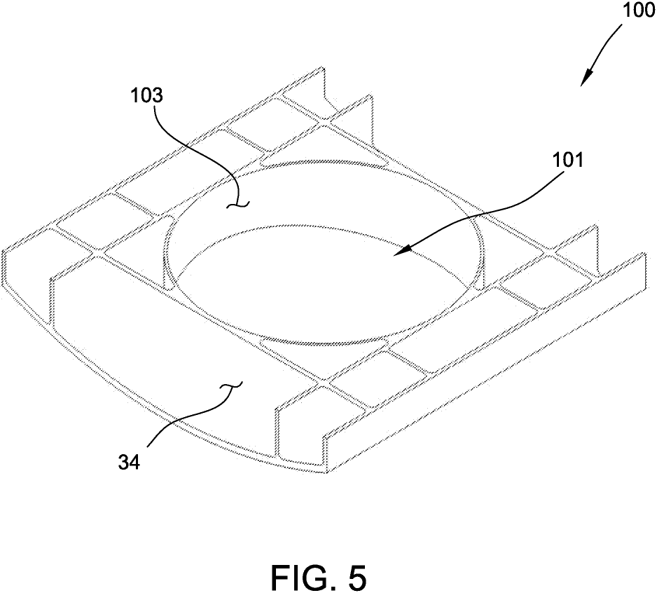

With reference to FIG. 5, the receptacle 100 may include a doubler 34 attached to the exterior of the outer skin 12 proximate the receptacle 100. The doubler 34 may include an opening congruent with the opening 101 of the receptacle 100. In the illustrated embodiment, the doubler 34 is a thin sheet of metal shaped to match a contour of the outer skin 12 proximate the receptacle 100. The doubler 34 is suitably connected to the outer skin 12 to enable the doubler 34 to function as described herein. For example, but not by way of limitation, the doubler 34 may be connected to the outer skin 12 using suitable fasteners, such as rivets, bolts, or the like. Additionally, in some embodiments, the doubler 34 may be structurally connected or directly attached to the housing 110 of the receptacle 100. Although referred to herein as a “doubler,” the doubler 34 is not limited to a thickness that doubles an original thickness of the outer skin 12 proximate the receptacle 100.

In some embodiments, the doubler 34 spans exteriorly from a continuous rib 22, across the at least one discontinuous rib 23, and to another continuous rib 22. In some embodiments, the span of the doubler 34 across the at least one discontinuous rib 23 at least partially compensates for the load bearing capability that is lost by removing, or by fabricating support structure 14 without, portions of the at least one discontinuous rib 23. In alternative embodiments, no doubler is used with receptacle 100.

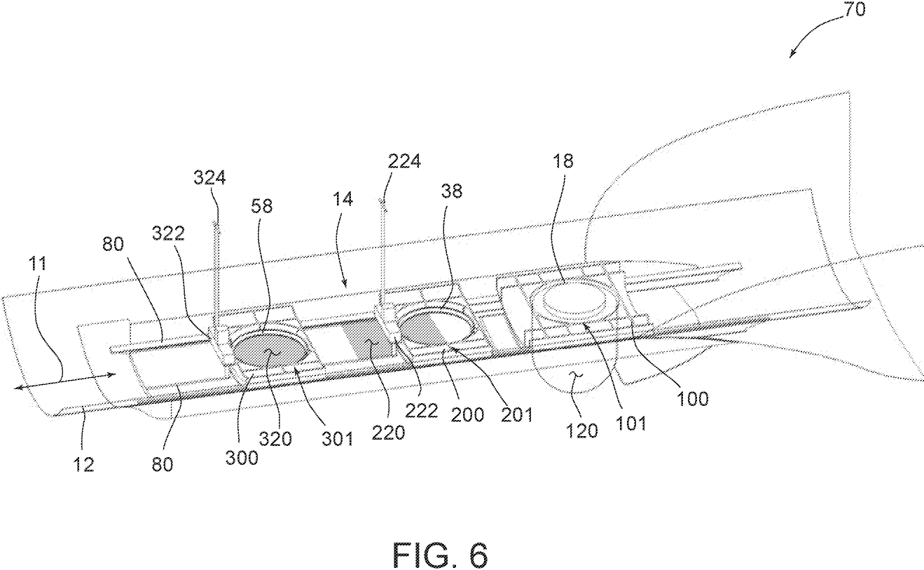

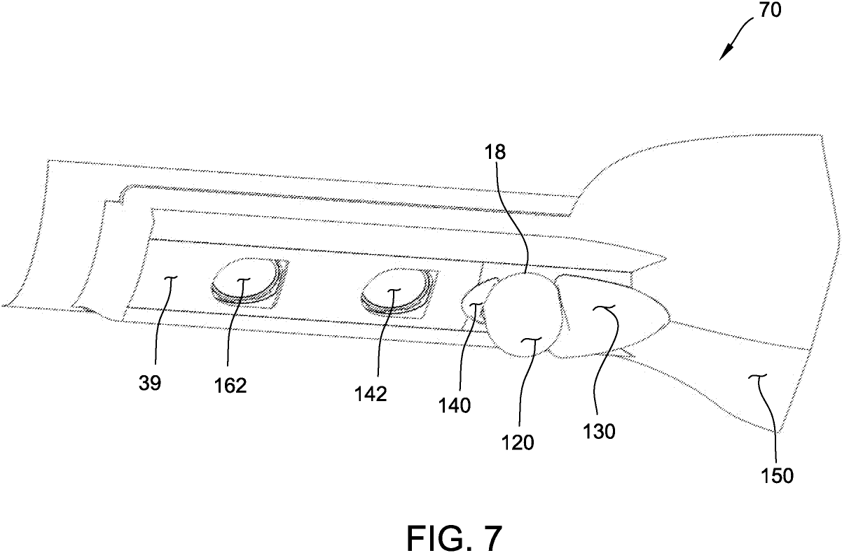

The opening 101 of the receptacle 100 is configured to receive and secure a ball-mounted sensor assembly 120 (shown in FIGS. 6 and 7) such that the ball-mounted sensor assembly 120 at least partially defines a pressure boundary between the interior of the aircraft 10 and the external environment. In the illustrated embodiment, the ball-mounted sensor assembly 120 and the opening 101 are each circular, though other shapes are contemplated within the scope of this disclosure. With reference to FIGS. 6 and 7, the ball-mounted sensor assembly 120 extends through the opening 101 in the receptacle 100 and downward of the outer skin 12. The ball-mounted sensor assembly 120 may be an electrooptical/infrared (EO/IR) ball, a radome, or any other suitable ball-mounted sensor.

In the first embodiment of an aircraft shown in FIG. 1, the port 18 is a first port 18 defining a first break in the support structure 14, and the receptacle 100 is a first receptacle 100 defining a first opening 101 therein. With reference to FIGS. 6 and 7, the multi-receptacle payload assembly 70 may additionally include a second port 38 and a third port 58. The second and third ports 38, 58 are both located forward of the first port 18 with respect to the longitudinal axis 11 in this embodiment. In other embodiments, the second and third ports 38, 58 may both be placed longitudinally aft of the first port 18, on either side of the first port 18, or in any other suitable configuration that allows the multi-receptacle payload assembly 70 to function as described herein. The multi-receptacle payload assembly 70 may also include a cover 39 that encloses the outer skin 12 and support structure 14 proximate the first, second, and third ports 18, 38, 58.

The second port 38 extends through the outer skin 12 and defines a second break in the support structure 14. A second receptacle 200 is attached to the support structure 14 proximate the second port 38 and defines a second opening 201 therein. The second opening 201 of the second receptacle 200 may be coaxial with and largely the same shape and size as the second break in the support structure 14. That is, the second opening 201 and the second break in the support structure 14 may be fully or partially aligned. Similarly, the third port 58 extends through the outer skin 12 and defines a third break in the support structure 14. A third receptacle 300 is attached to the support structure 14 proximate the third port 58 and defines a third opening 301 therein. The third opening 301 of the third receptacle 300 may be coaxial with and largely the same shape and size as the third break in the support structure 14. That is, the third opening 301 and the third break in the support structure 14 may be fully or partially aligned.

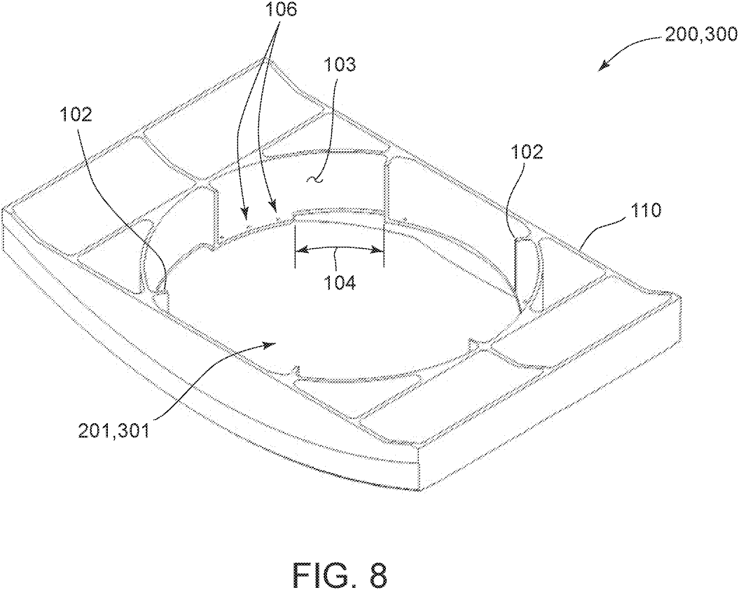

The second and third ports 38, 58 are substantially identical, and the second and third receptacles 200, 300 are substantially identical. In other embodiments, the second and third ports 38, 58 and the second and third receptacles 200, 300 may have one or more different features. The receptacle shown in FIG. 8 may be either the second or the third receptacle 200, 300. The second and third receptacles 200, 300 may be constructed similarly to the first receptacle 100, and common reference characters will be used for common components.

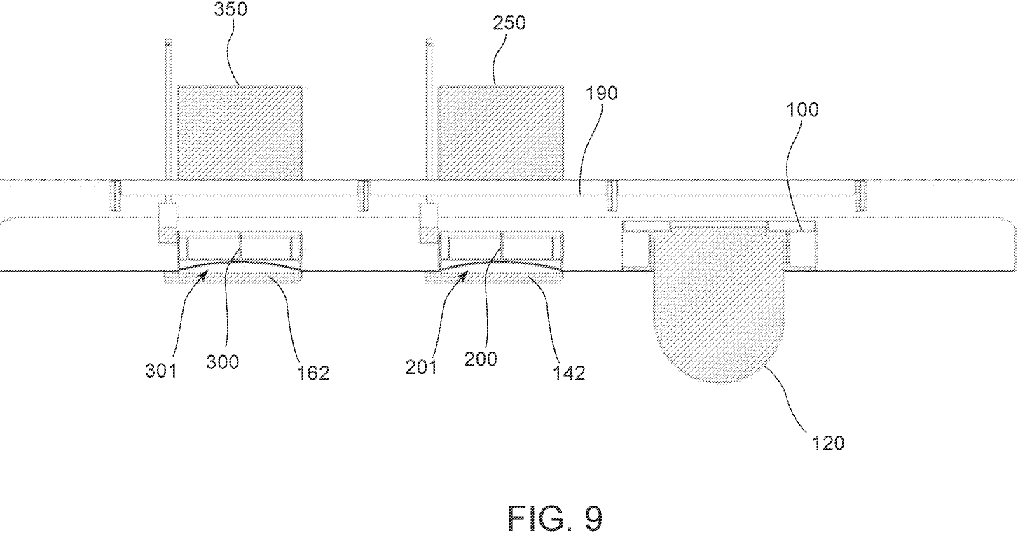

Each receptacle 200, 300 is installed in the respective port 38, 58 to facilitate installation and/or removal of a payload adjacent the port 38, 58. The payload is shown in FIG. 9. Each receptacle 200, 300 includes a plurality of circumferentially-spaced flanges 102 extending inwardly from the inner surface 103 of the housing 110 and configured to couple to a corresponding plurality of circumferentially spaced flanges extending outwardly from an outer surface of a mounting assembly (not shown). Each pair of receptacle flanges 102 defines a circumferential gap 104 therebetween. The receptacle flanges 102 and corresponding mounting assembly flanges are complementarily sized and spaced such that, in a first rotational orientation of the mounting assembly relative to the opening 201, 301 of the receptacle 200, 300, the mounting assembly flanges are receivable through the gaps 104, and in a second rotational orientation of the mounting assembly relative to the opening 201, 301 of the receptacle 200, 300, the mounting assembly flanges are aligned with the receptacle flanges 102.

With additional reference to FIG. 8, at least one receptacle flange 102 includes fastener openings 106 defined therein, and at least one mounting assembly flange includes corresponding fastener openings defined therein. More specifically, the respective flange fastener openings are spaced such that, when the mounting assembly is in the second orientation relative to the receptacle 200, 300, each pair of the fastener openings registers. A fastener (not shown) is receivable by each registered pair of fastener openings to couple the flanges together, thereby securing the mounting assembly to the receptacle 200, 300. For example, the mounting assembly flanges may include nut plates (not shown) into which the fasteners are secured. In alternative embodiments, the receptacle 200, 300 and/or the mounting assembly each includes any suitable structure that enables the mounting assembly to be received by, and secured to, the receptacle 200, 300.

In one example method of installing the mounting assembly within the receptacle 200, 300, the mounting assembly is positioned below the receptacle opening 201, 301 in the first rotational orientation, such that each mounting assembly flange aligns with a corresponding gap 104. For purposes of this disclosure, unless otherwise noted, terms such as “above” and “below” are used solely to describe relative positioning for purposes of explanation, and are not intended to limit the disclosure to an absolute orientation of the components described. The mounting assembly is then moved at least partially into the opening 201, 301, such that the mounting assembly flanges pass through the corresponding gaps 104 and are elevated above the level of the receptacle flanges 102. The mounting assembly is next rotated to the second rotational orientation, such that each receptacle flange 102 is aligned with a corresponding mounting assembly flange. For example, each receptacle flange 102 is aligned directly above a corresponding mounting assembly flange. The receptacle flanges 102 and the corresponding mounting assembly flanges are then coupled together to secure the mounting assembly within the receptacle 200, 300. In alternative embodiments, the mounting assembly is installed within the receptacle 200, 300 in any suitable fashion that enables the mounting assembly to function as described herein. The receptacle flanges 102 and/or the mounting assembly flanges may be scalloped and/or discontinuous to reduce a weight or mass of the mounting assembly.

Generally, the receptacle flanges 102 and/or the mounting assembly flanges are configured to prevent or inhibit incorrect installation of the mounting assembly within the receptacle 200, 300. For example, the mounting assembly is designed to be positioned in a preselected rotational orientation with respect to the receptacle 200, 300, and the receptacle flanges 102 and/or the mounting assembly flanges ensure that the mounting assembly can only be installed in the preselected orientation. Also, the receptacle flanges 102 and corresponding mounting assembly flanges are spaced asymmetrically, such that the mounting assembly flanges are only receivable through the receptacle flanges 102 when the mounting assembly is in a single orientation. For another example, at least receptacle flange 102 and its corresponding mounting assembly flange share a unique pattern of fastener openings or a unique key way, such that the mounting assembly flanges are only couplable to the receptacle flanges 102 when the mounting assembly is in the preselected orientation.

The receptacle 200, 300 and/or the payload may each include at least one guide (not shown) configured to facilitate aligning the mounting assembly flanges for insertion through the gaps 104 between the receptacle flanges 102. The receptacle 200, 300 and the mounting assembly may each include any suitable number of guides. Each guide is positioned such that, when the mounting assembly is aligned for insertion into the opening 201, 301, the guide interferes with at least one of a corresponding guide, a receptacle flange 102, or a mounting assembly flange to prevent the mounting assembly from rotating relative to the receptacle 200, 300 as the mounting assembly is inserted into the opening 201, 301. Once the mounting assembly flanges have passed above the receptacle flanges 102, the guides no longer interfere, such that the mounting assembly can be rotated relative to the receptacle 200, 300 to align the receptacle and mounting flanges for coupling. In some embodiments, the guides also provide a visual alignment guide for installation of the mounting assembly into the receptacle 200, 300. In alternative embodiments, neither the receptacle 200, 300 nor the mounting assembly includes any guides.

The spacing, sizing, and/or gap size of the receptacle flanges 102 and/or the mounting assembly flanges are such that the mounting assembly can only be inserted into the receptacle 200, 300 in a single orientation. Similarly, in some embodiments, the guides may be spaced such that the mounting assembly can only be inserted within the receptacle 200, 300 in a single orientation. The receptacle 200, 300 may also include at least one mechanical stop (not shown) to prevent the mounting assembly from being inserted too far through the opening 201, 301 of the receptacle 200, 300 and damaging internal components. That is, the mechanical stop prevents the mounting assembly from being inserted through the opening 201, 301 to depth at which the mounting assembly contacts another component, such as an imaging device or other equipment which may be susceptible to damage. The mechanical stop may be a tab protruding inwardly from the inner surface 103 of the receptacle housing 110 that interferes with at least one mounting assembly flange. The mechanical stop may be located at a depth defined beyond the receptacle flanges 102, with respect to the direction of insertion of the mounting assembly. The selected depth provides sufficient space for the mounting assembly flanges to be elevated vertically between the receptacle flanges 102 and the mechanical stop, to enable rotation of the mounting assembly into coupling alignment as described above. In alternative embodiments, the receptacle 200, 300 does not include a mechanical stop.

With reference to FIG. 9, the second and third receptacles 200, 300 respectively include first and second payloads 250, 350 mounted therein. The first and second payloads 250, 350 may be connected in part to the support structure 14, a floor assembly 190, or any other suitable part of the aircraft 10. The first and second payloads 250, 350 may be, for example, and without limitation, an optical imaging device, such as a camera or LiDAR system, an atmospheric monitor, a sonobuoy, another suitable sensor, antenna, ordnance, a countermeasure, or a collection/dispersion device. The first and second payloads 250, 350 may be the same, or they may be two different devices. The payloads 250, 350 may be controlled by a flight crew, by a remote operator, or they may be control.

The second and third receptacles 200, 300 each respectively include first and second single-pane windows 142, 162 positioned within the first and second openings 201, 301. In the illustrated embodiment, each window 142, 162 is circular and is made of glass, for example and without limitation, BK7 or N-BK7 glass. In alternative embodiments, each window 142, 162 may be made of or formed from any suitable material, for example, acrylic or polycarbonate, and may have any suitable shape that enables the window 142, 162 to function as described . The first and second single-pane windows 142, 162 may be at least partially transparent to electromagnetic radiation in at least one bandwidth, such as an optical bandwidth, an infrared bandwidth, or another suitable bandwidth within the electromagnetic spectrum. For example, the first and payloads 250, 350 may be an imaging device, for example at least one of a camera, a human observer, an illumination device, and another suitable sensor, positioned in an interior of the aircraft above the receptacle 200, 300 and adjacent the window 142, 162 such that the imaging device has a line of sight to an area to be imaged.

The aircraft 10 may further include a door assembly for selectively concealing the second and third ports 38, 58. The door assembly includes first and second doors 220, 320 and at least one rail 80 configured to be mounted to the support structure of the aircraft. The embodiment illustrated in FIG. 6 shows a door assembly having two rails 80, but the door assembly may have any suitable number of rails 80, for example and without limitation, one, three, or more rails 80. The first and second doors 220, 320 are slidably connected to the at least one rail 80 for movement between an open position and a closed second position. In the illustrated embodiment, the rails 80 are configured to be generally parallel to a longitudinal axis 11 of the aircraft 10, such that the first and second doors 220, 320 are slidable parallel to the longitudinal axis 11. In further embodiments, the rails 80 may be disposed in any suitable direction with respect to the aircraft 10.

The rails 80 are suitably aligned with and/or connected to a corresponding exterior member (not shown) on the exterior side of the outer skin, such that the exterior member provides support for the door assembly. For example, each rail 80 and corresponding interior member may be coupled together by suitable fasteners extending through the outer skin 12 of the aircraft 10. Moreover, in some such embodiments, the rails 80 cooperate with the exterior members to further enable the support structure 14 proximate the second and third ports 38, 58 to route the load borne by the support structure 14 around the break defined by each port 38, 58, as discussed above. For example, the rails 80 may span from a continuous rib 22, across at least one discontinuous rib 23, and to another continuous rib 22. In some embodiments, such a configuration at least partially compensates for the load bearing capability that is lost by removing, or by fabricating support structure 14 without, portions of the at least one discontinuous rib 23.

The door assembly is mounted such that the closed position of the first and second doors 220, 320 hides or conceals the second and third ports 38, 58 from external view, and the open position of the first and second doors 220, 320 reveals the second and third ports 38, 58 to the exterior environment. For example, and with reference to FIG. 6, the second door 320 is shown in the closed position, and the first door 220 is shown part way between the open and closed position. In the closed position, the payload is additionally concealed. Moreover, in some embodiments, the doors 220, 320 are configured to be difficult to see or visualize from the external environment. Each door 220, 320 is movable along the rails 80 to move to a different position. In further embodiments, the open and closed positions are oriented in any suitable fashion with respect to the longitudinal axis 11.

The door assembly protects and/or conceals the first and second payloads 250, 350 connected to each of the second and third receptacles 200, 300. Each door 220, 320 may be controlled or moved to the open or closed position by a suitable control system (not shown) when required by the mission or payload operation. The door operation may be controlled by a flight crew or, alternatively, by a remote operator. Control may be based on factors including the type of payload installed and mission requirements. Control may also be automatic in some cases, such as automatic closure when the landing gear are extended for landing. The control function can be mechanized by different means electrically or mechanically, and may also include a mechanical backup such as a manual override mechanism in case of electrical motor failure. In some embodiments, and with reference to FIG. 6, each door 220, 320 may be controlled by an actuator 222, 322 and/or a hand crank 224, 324 for manually moving each door 220, 320 between the open and closed positions. Thereafter, the door 220, 320 can be controlled to move to its first or closed position.

Generally, the door assembly is configured and installed to accommodate operation of the aircraft 10 in flight up to the limits of the aircraft ground and flight envelope. Alternatively if installed in a rotorcraft, through the ground and flight envelope of the rotorcraft including hover conditions, and in the case of a lighter than air vehicle throughout the ground and flight envelope. In some embodiments, retrofit of the aircraft 10 does not limit an operational profile of the aircraft 10.

The door assembly is added to the aircraft 10 in a retrofit operation. In alternative embodiments, the door assembly is included on the aircraft 10 as initially manufactured. In other alternative embodiments, the aircraft 10 does not include the door assembly. For example, the ports 38, 58 and/or the payload assemblies are not cloaked or hidden.

With reference to FIG. 7, the aircraft 10 includes a first aerodynamic feature 130 and a wing-root fairing 150 connected to the support structure 14 at a location longitudinally aft of the ball-mounted sensor assembly 120. The aircraft 10 additionally includes a fore-body fairing 140 connected to the support structure 14 at a location longitudinally forward of the ball-mounted sensor assembly 120. The first aerodynamic feature 130, wing-root fairing 150, and the fore-body fairing 140 minimize the drag force created by the ball-mounted sensor assembly 120 and reduce the risk of shocks and pressure waves forming. The first aerodynamic feature 130 may additionally be adapted to receive a third payload (not shown), such as a radome and/or antenna.

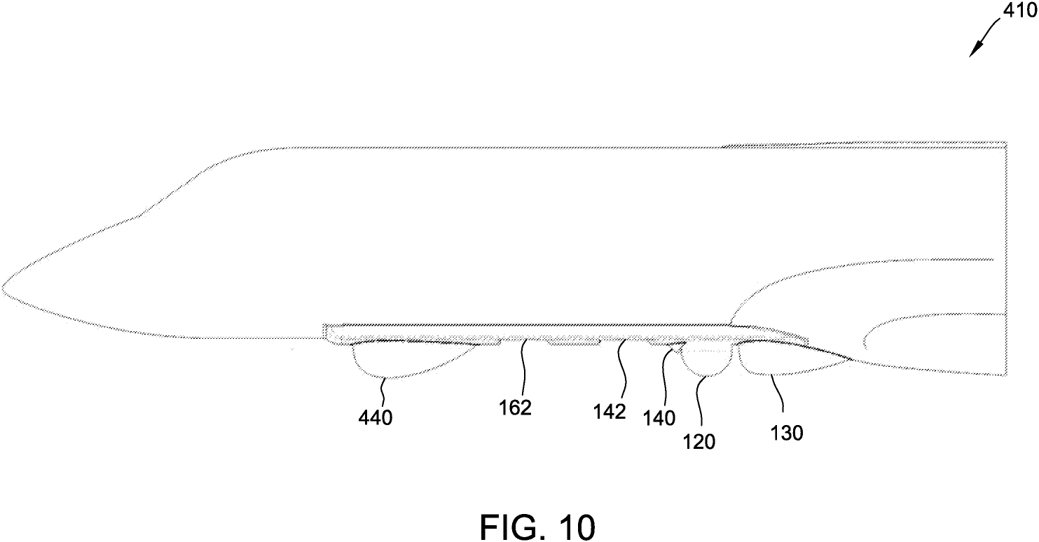

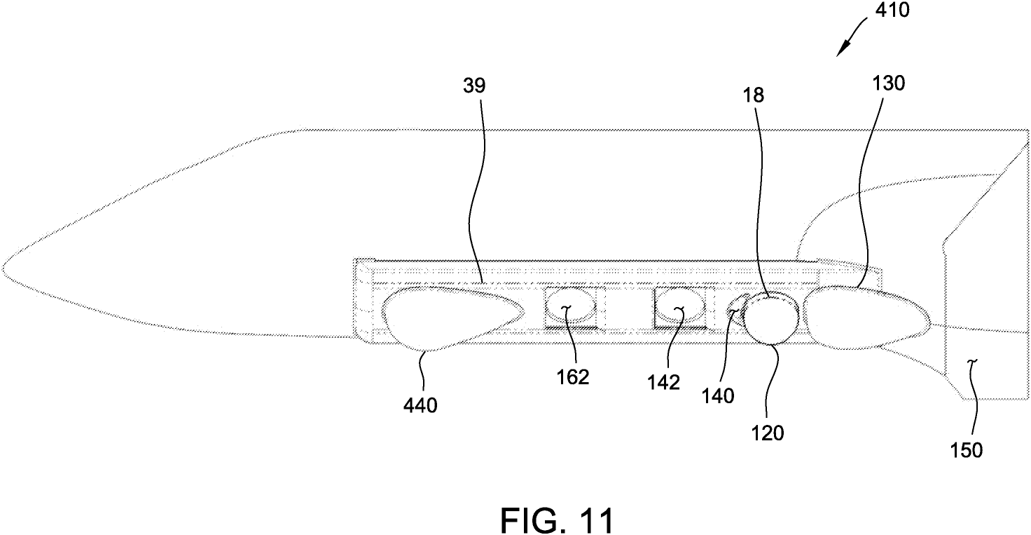

FIGS. 10 and 11 illustrate a second embodiment of an aircraft 410. In addition to the features of the first embodiment of an aircraft 10 shown in FIGS. 1-9, the aircraft 410 also includes a second aerodynamic feature 440 connected to the support structure 14 at a location longitudinally forward of the third port 58. In some embodiments, the second aerodynamic feature 440 may additionally be adapted to receive a fourth payload (not shown), such as a radome and/or antenna. Addition of the second aerodynamic feature 440 allows the aircraft 410 to carry two different types of payloads in the two aerodynamic features 130, 440.

An example method for retrofitting the aircraft 10 to accommodate the ball-mounted sensor assembly 120 and a removable payload includes removing a first portion of the support structure 14 to define a first break and placing a first port 18 in the first break such that the first port 18 extends through the outer skin 12. The method also includes connecting a first receptacle 100 to the support structure 14 proximate the first port 18, the first receptacle 100 defining a first opening 101, and placing the ball-mounted sensor assembly 120 within the first opening 101 of the first receptacle 100 such that the ball-mounted sensor assembly 120 extends downward from the outer skin 12. The method further includes removing a second portion of the support structure 14 to define a second break, placing a second port 38 in the second break such that the second port 38 extends through the outer skin 12, connecting a second receptacle 200 to the support structure 14 proximate the second port 38, the second receptacle 200 defining a second opening 201 therein, and placing the removable payload assembly within the second opening 201 of the second receptacle 200.

The method may further include connecting a door 220 to at least one rail 80 proximate the second port 38 such that the door 220 is slidably movable along the at least one rail 80 between an open position and a closed position. In some embodiments, connecting the second receptacle 200 to the support structure 14 comprises connecting an integrally formed housing 110 of the receptacle 200 to the support structure 14, wherein the housing 110 is shaped to be received in the second port 38. Additionally, connecting the payload within the receptacle opening 201 may include connecting the payload such that the payload at least partially defines a pressure boundary between an interior of the aircraft 10 and an external environment. The method may additionally include connecting a first aerodynamic feature 130 to the support structure 14 axially aft of the ball-mounted sensor assembly 120, and/or connecting a fore-body fairing 140 to the support structure 14 axially forward of the ball-mounted sensor assembly 120.

In embodiments in which the payload is a first payload 250, the method may include removing a third portion of the support structure 14 to define a third break, placing a third port 58 in the third break such that the third port 58 extends through the outer skin 12, and connecting a third receptacle 300 to the support structure 14 proximate the third port 58. The third receptacle 300 defines a third opening 301 therein, and then a second payload 350 is placed within the third opening 301 of the third receptacle 300. In such embodiments, the method may further include placing a single-pane window 142, 162 in each of the respective openings 201, 301 of the second or third receptacles 200, 300. Additionally, placing the first or second payload 250, 350 in the respective opening 201, 301 of the second or third receptacle 200, 300 may also include placing an imaging device adjacent the single-pane window 142, 162.

Embodiments of the systems and methods disclosed enable more efficient installation, removal, and/or replacement of a payload within an aircraft. Such systems and methods facilitate rapid removal and/or replacement of a damaged payload, as well as changing or swapping a type of payload, such as a window for another type of component like a dispersion device. The ability to efficiently change payloads significantly increases the utility of the aircraft. In some embodiments, the payload at least partially defines a pressure boundary between an interior of the aircraft and an external environment. The systems and methods disclosed also provide for retrofitting, or alternatively initially manufacturing, an aircraft to include a port for the removable payload, and a receptacle that receives the removable payload and routes at least a portion of the load borne by the support structure of the aircraft around the break defined by the port. In some embodiments, the receptacle enables a relatively large portion of the support structure proximate the port to be removed to accommodate a larger payload, without reducing the structural integrity of the aircraft. The support structure also allows for future growth and flexibility in the types and sizes of payloads the aircraft can accommodate.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a,” “an,” “the,” and “said” are intended to mean that there are one or more of the elements. The terms “comprising,” “including,” “containing,” and “having” are intended to be inclusive and mean that there may be additional elements other than the listed elements. The use of terms indicating a particular orientation (e.g., “top,” “bottom,” “side,” etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. An aircraft comprising:
a support structure;
an outer skin connected to the support structure;
a first port extending through the outer skin and defining a first break in the support structure;
a first receptacle attached to the support structure proximate the first port and defining a first opening;
a ball-mounted sensor assembly received in the first receptacle and extending downward from the outer skin;
a second port extending through the outer skin and defining a second break in the support structure;
a second receptacle attached to the support structure proximate the second port and defining a second opening;
a payload mounted in the second receptacle; and
a door selectively positionable over the second port and movable between an open position and a closed position.

2. The aircraft of claim 1, wherein the payload is a first payload, wherein the door is a first door, and wherein the aircraft further comprises:
a third port extending through the outer skin and defining a third break in the support structure;
a third receptacle attached to the support structure proximate the third port and defining a third opening;
a second payload mounted in the third receptacle; and
a second door selectively positionable over the third port and movable between an open position and a closed position.

3. The aircraft of claim 1, wherein the second receptacle includes a single-pane window positioned within the second opening.

4. The aircraft of claim 3, wherein the payload comprises an imaging device positioned adjacent the single-pane window.

5. The aircraft of claim 3, wherein the single-pane window is at least partially transparent to electromagnetic radiation in at least one of an optical bandwidth and an infrared bandwidth.

6. The aircraft of claim 1 further comprising a first aerodynamic feature connected to the support structure longitudinally aft of the ball-mounted sensor assembly.

7. The aircraft of claim 6, wherein the first aerodynamic feature is adapted to receive a third payload.

8. The aircraft of claim 1 further comprising a second aerodynamic feature connected to the support structure longitudinally forward of the second port.

9. The aircraft of claim 8, wherein the second aerodynamic feature is adapted to receive a fourth payload.

10. The aircraft of claim 1, wherein the ball-mounted sensor assembly comprises an electro-optical/infrared ball.

11. The aircraft of claim 1 further comprising a fore-body fairing connected to the support structure longitudinally forward of the ball-mounted sensor assembly.

12. A method of retrofitting an aircraft to accommodate a ball-mounted sensor assembly and a payload, the aircraft including a support structure and an outer skin, the method comprising:
removing a first portion of the support structure to define a first break;
placing a first port in the first break such that the first port extends through the outer skin;
connecting a first receptacle to the support structure proximate the first port, the first receptacle defining a first opening;
placing the ball-mounted sensor assembly within the first opening of the first receptacle such that the ball-mounted sensor assembly extends downward from the outer skin;
removing a second portion of the support structure to define a second break;
placing a second port in the second break such that the second port extends through the outer skin;
connecting a second receptacle to the support structure proximate the second port, the second receptacle defining a second opening therein; and
placing the payload within the second opening of the second receptacle.

13. The method of claim 12, wherein the payload is a first payload, and wherein the method further comprises:
removing a third portion of the support structure to define a third break;
placing a third port in the third break such that the third port extends through the outer skin;
connecting a third receptacle to the support structure proximate the third port, the third receptacle defining a third opening therein; and
placing a second payload within the third opening of the third receptacle.

14. The method of claim 13 further comprising placing a single-pane window in each of the respective openings of the second and third receptacles.

15. The method of claim 14, wherein placing the first or second payload in the second or third opening of the second or third receptacle comprises placing an imaging device adjacent the single-pane window.

16. The method of claim 12 further comprising connecting a door to at least one rail proximate the second port such that the door is slidably movable along the at least one rail between an open position and a closed position.

17. The method of claim 12, wherein connecting the second receptacle to the support structure comprises connecting an integrally formed housing of the second receptacle to the support structure, the housing shaped to be received in the second port.

18. The method of claim 12, wherein placing the payload within the second receptacle opening further comprises placing the payload such that the payload at least partially defines a pressure boundary between an interior of the aircraft and an external environment.

19. The method of claim 12 further comprising connecting a first aerodynamic feature to the support structure longitudinally aft of the ball-mounted sensor assembly.

20. The method of claim 12 further comprising connecting a second aerodynamic feature to the support structure longitudinally forward of the second port.
